(19) United States
(12) Patent Application Publication
(10) Pub. No.: US 2012/0029998 A1
(43) Pub. Date: Feb. 2, 2012

(54) PROMOTIONAL CONTENT AND COUPON DELIVERY

(75) Inventors: JESSE AVERSANO, Yorktown Heights, NY (US); William Christie, Fairfield, CT (US); Amy Davenport, Bethel, CT (US); Henri Lellouche, Fairfield, CT (US)

(73) Assignee: News America Marketing Properties, LLC

(21) Appl. No.: 13/191,044

(22) Filed: Jul. 26, 2011

Related U.S. Application Data
(60) Provisional application No. 61/369,351, filed on Jul. 30, 2010.

(51) Int. Cl. G06Q 30/00

(52) U.S. Cl. 705/14.27; 705/14.1; 705/26.1; 705/26.8

(57) ABSTRACT

Systems and methods provide interactive functionality and the ability for integrating coupon delivery with the use and features of a variety of portable, electronic devices. Coupons, advertisements, and/or other types of promotional content may be directed to a user's device from one or more of a plurality of sources. The presentation, use, and/or rendering of such promotional content is configurable according to, e.g., a consumer's preferences, an advertiser or coupon provider's preferences, and/or in an electronic FSI format, from which coupons may be printed, utilized in e-commerce, and/or linked to one or more loyalty cards/frequent shopper cards or accounts, for subsequent redemption. Shopping lists may be created with information regarding products based on such promotional content, and or the retrieval of product identifying information. Implementation of the systems and methods includes embedding promotional content into various types of media content, and/or via a standalone application.

### CROSS-REFERENCE TO RELATED PATENT APPLICATIONS

This application claims priority from Provisional Application U.S. Application 61/369,351, filed Jul. 30, 2010, incorporated herein by reference in its entirety.

### FIELD OF THE INVENTION

Various embodiments relate generally to the field of promotional content delivery. More particularly, various embodiments relate to promotional content generation, as well as distribution to and redemption using various electronic devices to create an interactive, electronic free standing insert (FSI) consumer experience.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Traditional marketing approaches have included the use of promotional content in the form of, e.g., advertisements and/or discount offers distributed to consumers in the form of paper or printed discount certificates commonly referred to as coupons. Coupons are generally distributed via, e.g., mailers or newspaper cutouts, or presented to consumers at a retail location. These coupons typically contain transactional data describing a particular transaction enabled by the coupon, such as a product's description, the coupon's amount or value, an expiration date, etc. Additionally, such coupons may contain certain identification data, e.g., various numbers, letters, barcodes or other symbols sufficient to uniquely identify the coupon and/or the product or service to be discounted. For example, upon presentation of a coupon at a point-of-sale terminal, the coupon could be scanned or otherwise identified and the requisite discount or value associated with the coupon could be applied to a purchased product.

With the advent of the Internet, online shopping and advertising has become more prevalent. For example, many retailers now maintain websites to allow consumers to shop online for products and/or obtain certain information related to such products. Additionally, many businesses now also provide coupons to consumers in an electronic format. That is, coupons can be sent to consumers via email, where the email contains a graphic representation of a coupon that can be printed by the consumer at his/her local printer. The printed coupon can then be taken to a retail location and redeemed by the consumer. Moreover, consumer utilization of portable and often wireless electronic devices, including, but not limited to personal digital assistants (PDAs), tablet personal computers (PCs), e-readers, personal media player (PMP) devices, has exploded, as has the convergence between these devices and the Internet or other type(s) of data networks. For example, advertising can be directed to users of such devices via, e.g., wireless telephonic communication systems, mobile video services, mobile Internet browsing, etc. Additionally, devices are now able to receive/render electronic tickets for redemption via, e.g., barcode or image scanning, or radio frequency (RF) transmission of electronic ticket information, directly from the device. Consumers are more reliant upon such devices as they gain increasing functionality, and the ability to support additional services.

In light of the aforementioned increasing reliance on electronic devices, such as, e.g., tablet PCs, it would be advantageous to provide systems and methods, such as a standalone and/or integrated application that may be implemented on such electronic devices to allow consumers to receive, e.g., a fully interactive and electronic FSI experience.

### SUMMARY OF THE INVENTION

Various embodiments are directed to providing interactive functionality and the ability for integrating coupon delivery with the use and features of a variety of portable and/or wireless, electronic devices. Coupons, advertisements, and/or other types of promotional content may be directed to a user's device from one or more of a plurality of sources, e.g., a coupon generation system, location-based service coupon providers, coupon dispensers, etc. The presentation and/or rendering of such promotional content is configurable according to, e.g., a consumer's preferences. For example, such promotional content may be presented in an electronic FSI (“free-standing insert”) format, from which coupons may be printed, utilized in e-commerce, and/or linked to one or more loyalty cards/frequent shopper cards or accounts, for subsequent redemption. Shopping lists may be created with information regarding products based on such promotional content, and or the retrieval of product identifying information. Functionality is also provided to coupon providers, retailers, advertisers, etc. to maintain control over the distribution of the promotional content, and to minimize fraudulent use and redemption of promotions.

Various embodiments may be implemented via a standalone application that is resident upon a user's device, or via promotional content embedded into various types of media content, such as e-books, ePub documents, multimedia content, etc. Existing applications and/or resident features on a user's device may be exploited by the embedded promotional content and/or the standalone application, such as interacting with, e.g., geo-location functionalities, communication capabilities, etc. to achieve the interactive functionality and integration of coupon delivery with a portable and/or wireless, electronic device.

Various embodiments are directed to alternate methods of redemption of coupons and promotional content by consumers, including print-at-home and presentation of paper coupons at the point-of-sale (POS), transfer to a consumer's loyalty or frequent-shopper card and redemption via presentation of the shopper's loyalty card or other identifier, wireless transfer from the consumer's mobile device to the POS, using, for example, a wireless network, WiFi or other mobile Internet connection, infrared transmission or optical transmission via the bar code reader at the POS.

These and other advantages and features of various embodiments, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

Embodiments of the present invention are described by referring to the attached drawings, in which:

FIG. 1 is an exemplary process flow in the lifecycle of an electronic coupon;

FIG. 2 illustrates an exemplary system architecture of a coupon system;

FIG. 3 illustrates the functional architecture of the coupon system of FIG. 2;

FIG. 4 illustrates the application architecture of the coupon system of FIG. 2;

FIG. 5 illustrates an exemplary authentication process for authenticating a user accessing an integrated content management system application of the coupon system of FIG. 2;

FIG. 6 illustrates an exemplary implementation of the coupon system of FIG. 2 in a distributed environment;

FIG. 7 illustrates an exemplary implementation of an electronic FSI in accordance with various embodiments; and

FIG. 8 illustrates an exemplary tablet PC couponing system architecture.

### DETAILED DESCRIPTION OF VARIOUS EMBODIMENTS

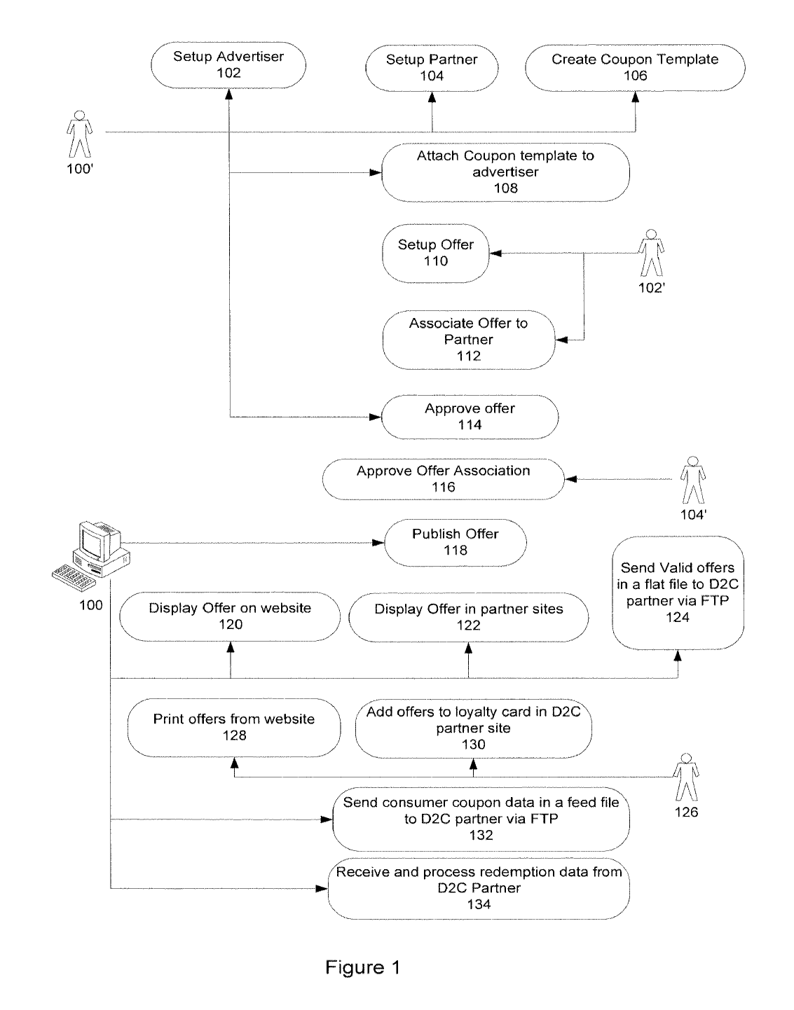

Various embodiments provide for the generation of promotional content, as well as the distribution and redemption thereof. It should be noted that the term promotional content may encompass advertisements, coupons, other types of promotional media in any form, digital or otherwise, or some combination thereof. It should also be noted that the terms coupon and advertisement may be used interchangeably, such that the systems, devices, apparatuses, as well as the methods, processes, procedures described herein may be applicable to/utilized in the context of any of the aforementioned promotional content(s). FIG. 1 illustrates an exemplary process flow in the lifecycle of an electronic coupon. As described above, electronic coupons can be provided to a user (e.g., consumer) directly by an advertiser or even a product or service retailer. Alternatively, product or service providers, retailers, or marketers may collaborate with a coupon distributor that operates a coupon system to provide coupon generation and/or an online network or distribution channel for electronic coupons. With reference to FIG. 1, an administrator 100′ of a coupon system 100 is shown as setting up an “advertiser” at 102, a “partner” at 104, and/or a coupon template at 106 to allow the advertiser 102′ to include any relevant data or details regarding the coupon. That is, the administrator 100′ obtains and enters relevant advertiser 102′ and partner 104′ information, and configures the coupon system 100 for use with the advertiser 102′ and/or partner 104′. As utilized herein, the term “advertiser” may refer to a client (of or relative to the coupon distributor and coupon system) sponsoring offers, e.g., a marketing entity or consumer packaged goods company. A “partner” can refer to a client (of or relative to the coupon distributor and coupon system) such as, e.g., a network distribution partner of the coupon distributor that distribute products, e.g., General Mills™, Coca-Cola™ Procter & Gamble™, etc. It should be noted that advertisers and partners may also be considered to be users of the coupon system 100 (e.g., when the advertiser creates coupons using a coupon template, when the partner approves coupon association, etc. as described in greater detail below). It should also be understood that FIG. 1 illustrates single instances of the administrator, the coupon distributor, the advertiser, and the partner merely for simplicity. However, various embodiments contemplate the involvement of any number of, combination, or groups of these entities.

At 108, the administrator 100′ associates or assigns the coupon template to the advertiser 102′. At 110, the advertiser 102′ uses the coupon template associated with or assigned to the advertiser 102′ and creates an offer while providing the relevant details associated with the coupon. At 112, the advertiser 102′ associates the created offer with a partner 104′. At 114, the administrator 100 validates and approves the offers created by the advertiser 102′, and at 116, the partner 104′ verifies and approves any offers associated therewith.

At 118, the approved offers are published online. Examples of online publishing include, but are not limited to displaying the offer on a website (provided via the coupon system 100) at 120, displaying the offer at one or more partner websites at 122, and sending the offer to a “Direct-to-card” (D2C) partner in a feed file at 124 using, e.g., a file transfer protocol (ftp). A D2C partner can refer to a retailer or other entity that offers loyalty cards, where the coupon system 100 can send the offer or coupon directly to a retail loyalty card associated with a particular consumer.

From a consumer perspective, a consumer 126 may select one or more desired coupons for printing. That is, from either the coupon system website or a partner website, the consumer 126 may access one or more coupons and print them locally at a printer. Alternatively at 130 and in accordance with the D2C scenario, the consumer may select the one or more desired coupons to be added to his/her retail loyalty card. At 132, the coupon system 100 sends the consumer loyalty card number and the selected coupons data in a feed file to the D2C partner via FTP. Thereafter, at 134, the coupon system 100 receives and processes a redemption data feed file obtained from the D2C partner.

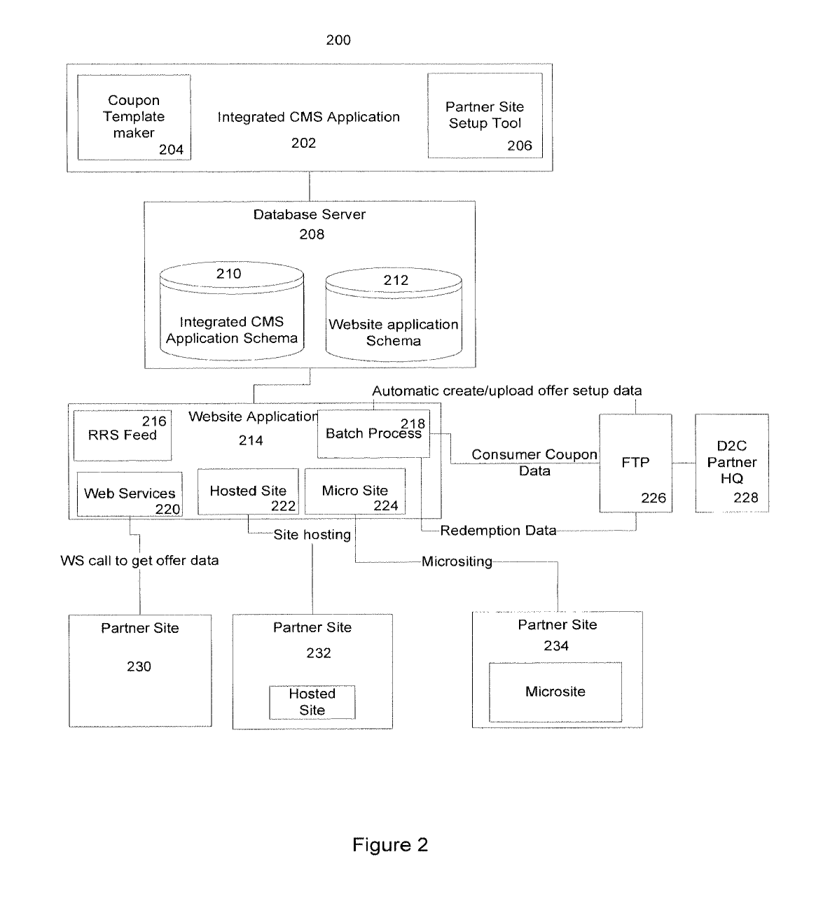

FIG. 2 illustrates an exemplary system architecture of a coupon system 200 (which would be operated and provided by, e.g., a coupon distributor) through which various embodiments may be implemented and effectuated. The coupon system 200 includes an “integrated content management system (CMS) application” 202. The integrated CMS application 202 can be used to: create coupon templates using an integrated coupon template maker tool 204; create and setup advertisers, partners, and offers as described above; and setup a partner's (that opt for site hosting) website using a partner site setup tool 206.

The coupon system 200 further includes a database server 208 that is common to the integrated CMS application 202 and the coupon system website. It should be noted that the coupon system website is effectuated by a “website application” 214 for performing the requisite processes described in greater detail below. Additionally, it should be noted that both the integrated CMS application 202 and the website application 214 can have their own independent schemas 210 and 212, respectively. That is, offer setup data flows into both the schemas 210 and 212 from the integrated CMS application 202, and is used by the website application 214 for display and integration with partner sites.

The website application 214 provides a “public-facing” website that hosts one or more webpages containing electronic coupons for display and printing by consumers. The website application 214 fetches electronic coupons from the common database server 208 between the website application 214 and the integrated CMS application 202 and displays the electronic coupons. Thus, a consumer may visit the coupon system website and browse or access one or more desired offers, and print coupons for the desired offers. The website application 214 also provides options for integration with partners. Further still, the website application 214 hosts, e.g., a Real Simple Syndication (RSS) feed 216 which is open to the public, allowing consumers to subscribe to the RSS feed 216 to receive electronic coupon data on a frequently updated basis. It should be noted that other types of web syndication or data aggregator technology may be utilized in accordance with various embodiments.

As described above, various embodiments provide the ability for a coupon distributor to send an offer or coupon directly to a retail loyalty card associated with a particular consumer via D2C partner integration. The D2C partner integration is done using a batch process component 218 hosted in a server that hosts the coupon system website, where the batch process component 218 periodically creates a flat/feed file containing the offer setup data. The file is transmitted to an ftp server 226 to be picked up by the D2C partner headquarters (HQ) 228. The batch process component 218 also creates and transmits consumer coupon data to the D2C partners, as well as imports and processes the redemption data feed file from the D2C partners transmitted via the ftp server 226.

Partner sites, such as partner sites 230, 232, and 234 illustrated in FIG. 2, are integrated with the website application 214 using various methods. In accordance with a first method, the website application 214 exposes one or more web services 220 that provide the coupon data for a particular partner. The partner can consume the web services 220 by giving out their partner ID to get coupon details. Additionally, the partner, if they so desire, can apply their own rendering logic to display the coupon on their own partner site 230.

In accordance with another method, partner site integration involves presenting the coupon system website as a “microsite” 224 on the partner site 234. For example, the partner may include an iframe inside their own partner site/website 234, where the source will point to the coupon system website that hosts/displays the coupon data.

Further still, a method of site hosting may be utilized to effectuate partner site integration. In accordance with this method, partner site integration begins with partner site setup in the integrated CMS application 202 as described above. Once a partner site 232 is setup in the integrated CMS application, the website application 214, via a hosted site module 222, retrieves the data to display coupon data on a webpage whose look and feel will be the same as that of the partner site 232. It should be noted that this entire webpage can be hosted by one or more servers hosting the coupon system website, or alternatively, dedicated web servers.

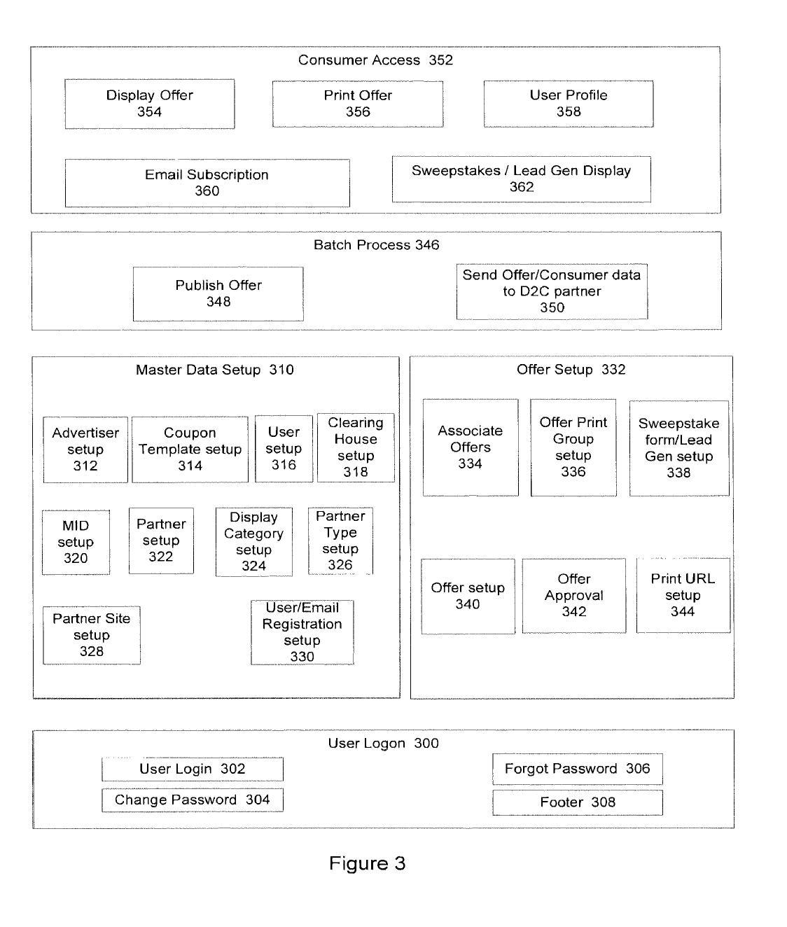

FIG. 3 illustrates the functional architecture of the coupon system described above. From a functionality perspective, a User Logon module 300, a Master Data Setup module 310, and an Offer Setup module 332 make up the integrated CMS application. A Batch Process module 346 and a Consumer Access module 352 make up the website application. It should be noted that more or less modules may be implemented within or as part of the integrated CMS application and/or website application while providing substantially similar functionality. For example, one of the aforementioned modules may be implemented in another entity of the system 200 described above. It should be further noted that each of these modules may include one or more respective user interfaces (UIs), such as, e.g., web-based graphical UIs (GUIs), and associated processes for accomplishing the various module tasks or providing user access for inputting the requisite information needed to accomplish the various module tasks.

The User Logon module 300 is configured to handle various aspects of user access and identification. For example, the User Logon module 300 controls user login processes 302, change password 304 and forgotten password 306 functionalities, as well as a footer 308 functionality in the integrated CMS application. It should be noted that all users of the integrated CMS system including, e.g., any administrators, advertisers, and/or partners, may access these features for their respective purposes, e.g., providing consumer access requirements/data for accessing a partner site or the coupon system website, etc.

The Master Data Setup module 310 deals with any master data setup-related functionalities. Such functionalities include, but are not limited to, the following: advertiser setup 312 (e.g., loading advertiser information into the coupon system); coupon template setup 314 (e.g., setting up coupon template layouts, offer information to be rendered, etc.); user setup 316 (e.g., setting up username and password for authorization, creating privileges and roles, assigning roles to users, etc.); clearinghouse setup 318 (e.g., maintaining an agency/company responsible for settling trading accounts, collecting and maintaining marginal monies, bringing together seekers and providers of goods, etc.); member identifier (MID) setup 320 (e.g., setting up a client's unique identifier for each member/registered consumer); partner setup 322 (e.g., setting up one or more partners, e.g., retailers or network distribution partners); display category setup 324 (setting up display categories or product types that are specified when an offer is setup, for filtering or grouping offers for consumers); partner type setup 326 (e.g., setting up partners based on whether the partner is, e.g., a “registration required” partner); partner site setup 328 (e.g., setting up micrositing information such as whether or not a microsite will contain iframes, other visual attributes, etc.); and user/email registration setup 330 (e.g., setting up a user registration process for the required registration type). All of these features are functionally a part of the integrated CMS application and can be accessed by an administrator.

The Offer Setup module 332 is configured to group certain functionalities, including but not limited to, the following: associating offers 334 (e.g., associating offers or disassociating offers with partner sites); offer print group setup 336 (e.g., setting effective coupon dates, setting offer group print limits, etc.); sweepstake form/lead generation setup 338, offer setup 340 (e.g., setting up offers specifying a type of offer provided and other related information); offer approval 342 (setting up the ability for partners to approve advertiser-submitted/created offers); and print URL setup 344 (generating print URLs associated with offers promoted by, e.g., a partner at a partner site, setting print limits, etc.) With regard to the aforementioned sweepstake form/lead generation setup 338, it should be noted that the coupon system may be used not only for coupon generation and distribution, but for sweepstakes purposes as well. That is, forms may be created and used for sweepstake and lead generation, where when a consumer clicks on a link to a sweepstake/lead generation form, the consumer information entered into the form is recorded an passed on to the client holding the sweepstake promotion. The Offer Setup module 332 is also a part of the integrated CMS application and is primarily accessed by advertisers.

Before an offer is set up, a Letter of Commitment (LOC) should be created. The LOC is specific to a single advertiser, although multiple offer programs can exist for one or more brands of an advertiser in a single LOC, and the LOC can be associated with D2C or printable coupon distribution. Moreover, a single LOC can cater to multiple timelines and multiple distribution channels. There are different types of LOCs including, for example: a time-based LOC, where an offer is valid only for a contracted time period; a print-based LOC, where an offer is valid only until a predetermined print limit is reached; and a partnership-based LOC, which is similar to the print-based LOC, but also includes a “new coupon alert spotlight,” a “solo page,” and a “web link.” Additional LOC types include a coupon tech LOC which refers to a contract between the coupon distributor and an advertiser, where the advertiser purchases, e.g., a print URL. It should be noted that in certain instances, a print URL may be considered to be an advertiser function, and hence the advertiser may be setup as a partner. Yet another LOC type includes an account-specific LOC used for coupon programs distributed at a limited number of retail network sites instead of on the coupon distributor network/network channels.

It should be further noted that a LOC may only be created by, e.g., an administrator of the coupon distributor, and once the requisite information is submitted regarding the LOC, the LOC can be generated in a pdf format or Word format. Thereafter, the LOC is sent to the advertiser and to a finance division of the coupon distributor for approval. Various change rules and fees can be applied to LOC creation as appropriate. Additionally, brand category exclusivity can be applied to LOCs and are valid for specific time period.

The Batch Process module 346 is a part of the website application and handles offer/coupon publishing 348 and sending offer/coupon and consumer data to D2C partner 350, which occurs in as a background process(es) without any direct/human user interaction. For example, a plurality of offers/coupons may be collected into a set or “batch” and processed together for publication on, e.g., a partner site. Moreover, sending consumer data to the D2C partner functionality involves the previously described D2C partner integration, where the consumer data (e.g., retailer loyalty card number and any attached coupons) are written into a flat file and transmitted to the D2C partner via ftp, or some other appropriate file transfer method or protocol.

The Consumer Access module 352, like the Batch Process module 346, is part of the website application and contains features which are available to consumers through the coupon system website. Such features, which are available to the public, include, but are not limited to, offer/coupon display 354, offer/coupon print 356, user profile management 358, email subscription 360, and sweepstake/lead generation display 362.

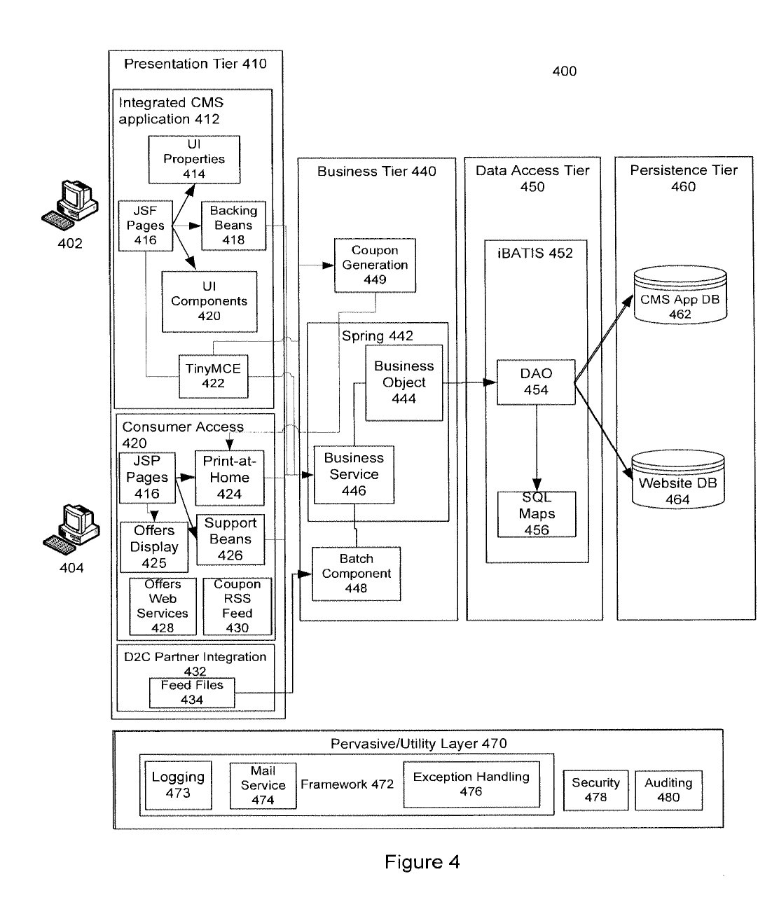

FIG. 4 is a diagram illustrating the application architecture of a coupon system 400. The application architecture is described in terms of “tiers” and the components within each tier. As shown in FIG. 4, the coupon system 400 includes a Presentation tier 410, a Business tier 440, a Data Access tier 450, a Persistence tier 460, and a Pervasive/Utility tier 470.

The Presentation tier 410 includes the integrated CMS application 412, a consumer access component 420, and a D2C partner integration component 432. The integrated CMS application 412 of the Presentation tier 410 utilizes JavaServer Faces (JSF) pages 416, a Java-based web application user interface (UI) development framework, to implement UI properties 414, backing beans 418 (for defining UI components/methods that perform UI component functions), and UI components 420. JSF differs from some other Model-View-Controller (MVC) frameworks in that JSF is a component-oriented and event-driven framework. JSF includes, among other features: a set of application programming interfaces (APIs) for displaying user GUI components and managing their state, handling events and input validation, page navigation using Extensible Markup Language (XML), etc.; tag libraries to access JSF components; predefined/default UI components; and server-side event handling. Additionally, the coupon system 400 utilizes MyFaces and RichFaces implementations of the JSF specifications. MyFaces is a particular JSF implementation promulgated by the Apache Software Foundation. RichFaces refers to a component library for JSF built on the Ajax framework, and includes Ajax components. Furthermore, the coupon system 400 utilizes various “custom” JSF components apart from the standard JSF components. It should be noted that other frameworks or development platforms may be utilized in accordance with various embodiments.

Moreover, the integrated CMS application 412 includes a “TinyMCE” tool to create coupon templates. TinyMCE is a JavaScript-based tool that provides rich text editing capabilities and allows saving a template in HTML format. This enables seamless integration of the coupon templates with the offer setup process. Custom visual as well as non-visual components may be created using the TinyMCE API to implement system-specific functionalities for the coupon template design process. For example, users such as advertisers may require the ability to add an image to a coupon template, resize it, and/or place the image in any position within the coupon template.

The Consumer Access component 420 of the Presentation tier 410 also utilizes JSF pages 416 to implement a print-at-home feature 424 and support beans 426. Additionally, the Consumer Access component 420 includes an offers web services feature 428, where the coupon system provides an integration option for partners through web services as described above. For example, the coupon system exposes a web service which provides coupon information for specific partners requesting it. The web service is hosted at the website application server and any end-point information may be given to those partners wishing to consume it. The partners use web services description language (WSDL) generated to consume the web service and provide their details in the request. Any coupons published for the partner are returned in a response to the partner request which is then rendered at the partner site using their own rendering logic.

A coupon RSS feed feature 430 is also provided in the Consumer Access component 420. Coupon data that will be available at the coupon system website may also be published as an RSS feed for consumers. Consumers may subscribe to this RSS feed and use a viewer tool to view coupon information at, e.g., their personal computer. This enables consumers to get updates regarding coupon information automatically at a computer without logging into the coupon system website.

The print-at-home component 424 that allows electronic coupons to be printed by a consumer may be embedded in the JSP and implemented using, e.g., an ActiveX and Java Applet client for MS Windows and Apple Mac-based clients, respectively. Such client components are preferably lightweight and can be used to get device IDs, e.g., the MAC address, of a client machine. Obtaining a device ID allows the coupon system to effectuate sending the coupon to a printer to be printed. Additionally, capturing the MAC address allows the coupon system, for example, to verify actual printing of a coupon. That is, the system can verify whether or not a print request/job is being sent to an actual printer/device rather than just some sort of data capture, such as a “print to file” request. Actual coupon generation will happen on the website server side using Hypertext Markup Language (HTML) to Portable Document Format (PDF) transformation. The generated PDF is sent to the client for printing using embedded JavaScript. Additionally, JSP pages 416 will also be utilized to implement the offer display component 425 for displaying offers/coupons on, e.g., the third-party coupon distributor website.

Further still, the Presentation tier 410 includes a D2C partner integration component 432, which as described above, involves writing consumer data (e.g., retailer loyalty card number and any attached coupons) into a flat file and transmitting it to the D2C partner via ftp.

The Business tier 440 follows a Service Oriented Architecture (SOA) pattern. That is, all business logic is accessible through a set of services. These services are entry points to the business logic layer and to access any business components.

Spring 442 is a flexible framework for the Java platform with convenient features including at least the following: flexible bean management; aspect-oriented programming (AOP) support; web MVC framework; integration with other frameworks' scheduling support, email utility; Java EE Connector Architecture (JCA) support, Java Management Extensions (JMX) support; Java Message Service (JMS) support; web services; Object Relational (O/R) tool integration; and declarative transaction management. Spring 442 also provides a high-degree of abstraction and uses inversion of control resulting in increased decoupling, configurability, and management. Spring 442 is used for managing the backing bean, business service 446, business objects 444, EJBProxy (not shown) and data access objects (DAO) 454. Spring components such as the following are utilized: “Spring Core” for implementing Dependency Injection and managing bean life-cycle of business services and business objects; “Spring Object Relational Mapping (ORM)” for providing a template for the iBATIS persistence framework; “Spring AOP” for declarative transaction management; and “Spring AOP” for Message Driven Bean (MDB).

Business service component 446 follows an “Application Service” pattern and is an entry point for any business-related operation. Again, it follows the standard (SOA) pattern, and uses the required business objects 444 and if necessary, calls a transaction manager to mark a transaction boundary in order to provide a service to the Presentation tier 410. The business object component 444 holds the business logic. If the business logic involves, e.g., database access, the business logic invokes appropriate DAOs of the Integration Tier to perform various database operations involved in accomplishing the functionality.

The Business tier 440 further includes a batch component 448 which receives any feed files 434 from the D2C partner integration component 432 using ftp. That is, information, such as offer data, coupons selected by a consumer, etc. are sent to the batch component 448 for batch processing as described above, and redemption information from partners may be received from partners. Offer publishing (as also described above) is yet another function that can be implemented as a batch process which will be triggered using, e.g., a CRON job scheduler utility.

In terms of transaction management, Spring's declarative transaction will be utilized. That is, a business service component 446 may initiate some transaction and the transaction context will automatically propagate to the business objects 444 by the transaction manager component of Spring. The business services component 446 may also be responsible for the overall management of transactions by starting, committing and marking the boundary of the transactions based upon, e.g., client requests, and providing necessary transactional contexts to all business objects 444.

As described above, the TinyCME tool 422 is used to create coupon templates. An actual coupon may then be generated using a coupon generation component 449 from an existing coupon template. Any associated offer details are fed into a selected coupon template and a new HTML coupon file is generated, which may then be printed, via, e.g., the print-at-home function 424. The Coupon HTML file is converted to XML using an HTML Tidy tool, which in turn is converted to a Transform Formatting object (XMLFO) using, e.g., XML transformer, or some similar document/file transforming tool. From the Formatting object and standard Extensible Stylesheet Language (XSL), a PDF file is generated and saved in the website server. An Acrobat script embedded in the PDF using iText enables PDF document printing in silent mode.

The Data Access tier 450 is used as the integration junction of the integrated CMS application 412 and the coupon system website/website application with the data tier. DAOs 454 are deployed in this tier, where DAO classes generally relate to specific business functionality and integrate the business tier with data tier. The Data Access tier 450 also aids in connecting relational database management systems (RDBMS) using a standard Java Database Connectivity (JDBC) API or an ORM tool to keep the Business tier 440 isolated from any underlying persistence mechanism. iBATIS 452 refers to a Data Mapper Framework, that in contrast to the traditional JDBC approach that constitutes many operations other than writing Standard Query Language (SQL) queries, reduces the amount of requisite Java code. That is, the iBATIS SQLMap framework significantly reduces the amount of Java code normally needed to access a relational database. Moreover, iBATIS effectively eliminates the mixing of Java code with SQL Code. DAO classes may extend and use base custom DAO classes provided by the third-party coupon distributor.

A Persistence tier 460 represents one or more databases and their constituents. In the example application architecture illustrated in FIG. 4, two data stores are shown as being utilized. A first database 462 is utilized for maintaining any integrated CMS application data. A second database 464 is utilized to store data from the coupon system website. The integrated CMS application 412 may be responsible for pushing data from its own database 462 to the second database 464. For example, once an offer is verified, the offer is pushed to the coupon system website database 464. The Data Access tier 450 uses JDBC to connect to the database 464 and iBATIS 452 uses the JDBC connection to perform various SQL operations to achieve data persistence.

A Pervasive/Utility layer 470 is also part of the application architecture 400. A framework 472 includes a Logging component 473, a Mail Service component 474, and an Exception Handling component 476. The Logging component 472 internally uses log 4j for tracking the exceptions/errors in the system. It should be noted that other logging utilities may be utilized other than the Java-based log 4j. Logging is provided as a default for all critical errors, and logging levels may be made configurable as needed. With log 4j, it is possible to enable logging at runtime without modifying the application binary, where statements can remain in shipped code without incurring a heavy performance cost. Further still, logging behavior can be controlled by editing a configuration file, without touching the application binary.

The Mail Service component 474 is a wrapper over the Java Mail API used to send/receive mail. The coupon system utilizes this API to send system-generated email notifications to, e.g., an administrator or consumer. Exception handling component 476 defines different types of exceptions relevant to each application tier. Various exceptions defined in the Framework 472 include, but are not limited to, DAO Exception, Business Exception, and Presentation Exception. Every layer/tier catches any potential run-time exceptions and converts them into layer-specific exceptions, where all exceptions may be logged with an easy to customize declarative mechanism. Meaningful error messages can be generated for display to a user such as an administrator or advertiser.

With regard to security, illustrated as a Security component 478, various embodiments utilize a “user to role” mapping mechanism. The role performs certain functionalities and users pertaining to the role will inherit all the behaviors of a particular role. Security with respect to the integrated CMS application involves a two-level authentication mechanism due to its use by internal and external users. That is, active directory authentication is provided for internal users, such as administrators of the coupon system, and database driven authentication is provided for external users, such as partners or advertisers. It should be noted that the active directory and/or the authentication database for external users may be configured as, e.g., one or more data repositories, that are separate from but accessible by or from the coupon system.

The Pervasive/Utility layer 470 may further include an Auditing component 480. Auditing can allow for maintaining an audit trail or a journaling function for, e.g., required database tables. Data administrators or database users can query a journal (history) table to measure changes, if any, that may have occurred over some particular period of time for a particular database table.

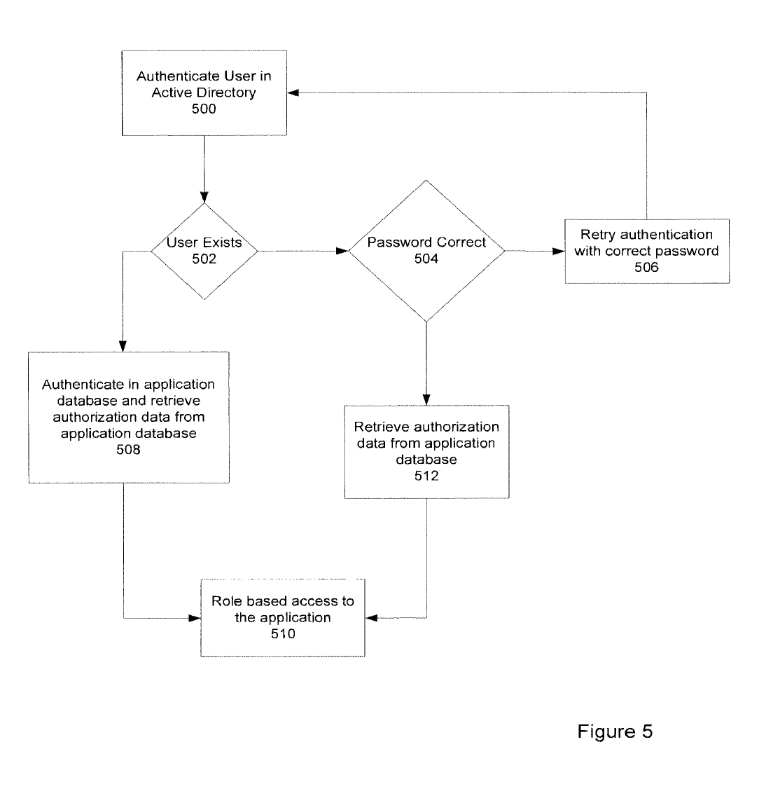

FIG. 5 illustrates the security authentication process, where a user (internal or external) is authenticated in the active directory at 500. At 502, it is determined whether the user exists. If the user does not exist in the active directly, the user is presumably an external user. Authentication is performed in the application database and authorization data is retrieved from the application database at 508. At 510, role-based access, as described above, is provided to the integrated CMS application for the external user. If it is determined at 502 that the user does exist in the active directory, the user is presumably an internal user. At 504, it is determined whether a password entered by the user is correct. If the password is not correct, authentication is retried at 506 with the correct password and returns to authentication of the user in the active directory at 500. If the password is deemed to be correct at 504, authorization data is retrieved from the application database at 512. Again, the appropriate role-based access is provided to the integrated CMS application at 510. It should be noted that active directory authentication may be implemented using, e.g., a Lightweight Directory Access Protocol (LDAP), authentication provider. Database driven authentication may be implemented using an appropriate user id/password authentication procedure.

Once a user's identity has been confined, the coupon system retrieves the accessible resources for the logged-in user based on Role Based Access Control (RBAC) from the database. Authorization is implemented using, e.g., URL-based web security and programmatic security. URL-based web security is performed by the website application server and is defined in web configuration files, where a virtual path is defined for each user group. Each virtual path is mapped to a security role, which is mapped to one or more groups. For example, a “/collections/” path is defined for the collection department of the third-party coupon generator/distributor, while a “/sales/” path is defined for sales users. Programmatic Security operates as follows. If a particular screen, such as a setup screen, is shared across multiple roles, e.g., one role is used to create an option and another role is used to approve it, the programmatic security framework will display an approve button only for its corresponding role. This is accomplished by associating the visibility and editability properties of the JSF components with the appropriate user privileges.

Security with regard to consumer access at the coupons system website will be made to be Secure Sockets Layer (SSL)-enabled by signing the coupon system website server with, e.g., an RSA-signed certificate from any trusted Certificate Authority (CA), e.g., VeriSign®, Thawte™, Comodo™, etc., although other security methods may be utilized. The coupons system website may also be configured not to accept any request on any non-secure ports to ensure that all communications to and from the website are secure. Enabling SSL ensures data security as it provides data encryption. Because the coupons system website is a publicly-accessible website available for consumers to access and print coupons pertaining to various offers, consumers need not necessarily register themselves to access/print coupons. Hence, no authentication is needed for consumers.

However, certain partners may require registration and for whom registration data is captured in coupon system. For such partners, a database authentication process is provided which will authenticate users (i.e., partners) using a user id and password captured during the registration process. Given that all users from a consumer access perspective are considered to be external users, there is no active directory authentication. Additionally, authorization is not needed for accessing the public-facing coupon system website.

Web services are secured using authentication, data-encryption and non-repudiation. With regard to authentication, web service clients will need to provide a user id and password for authentication in order to invoke a desired web service, such as provides coupon information for specific partners. A Servlet Filter is used to capture and intercept a request for the described web service, and initiate the authentication process. This filter may be configured with AxisServlet which handles all Simple Object Access Protocol (SOAP) requests. Additionally, the Servlet Filter will communicate with an authentication module to complete the authentication process. It should be noted that the authentication module implemented within the integrated CMS application can be reused for this purpose. User credentials will be sent from a client via an HTTP request. Data encryption and non-repudiation will be implemented using a Transport Layer Security mechanism configured by enabling SSL in the transport layer and installing an RSA signed certificate for the communication. There is no specific need for implementing authorization for accessing data via RSS feeds.

As indicated above, authorization is unnecessary for accessing data via RSS feeds. However, any coupon data published through RSS feeds will be secured by using SSL encryption. RSS Feeds are published via the coupon system website only, where the coupon system website will allow communication only through HTTPS. Thus, any RSS feeds will automatically be secured by the same secure channel. There is no specific need for implementing authentication or authorization for accessing coupon data via the RSS feeds.

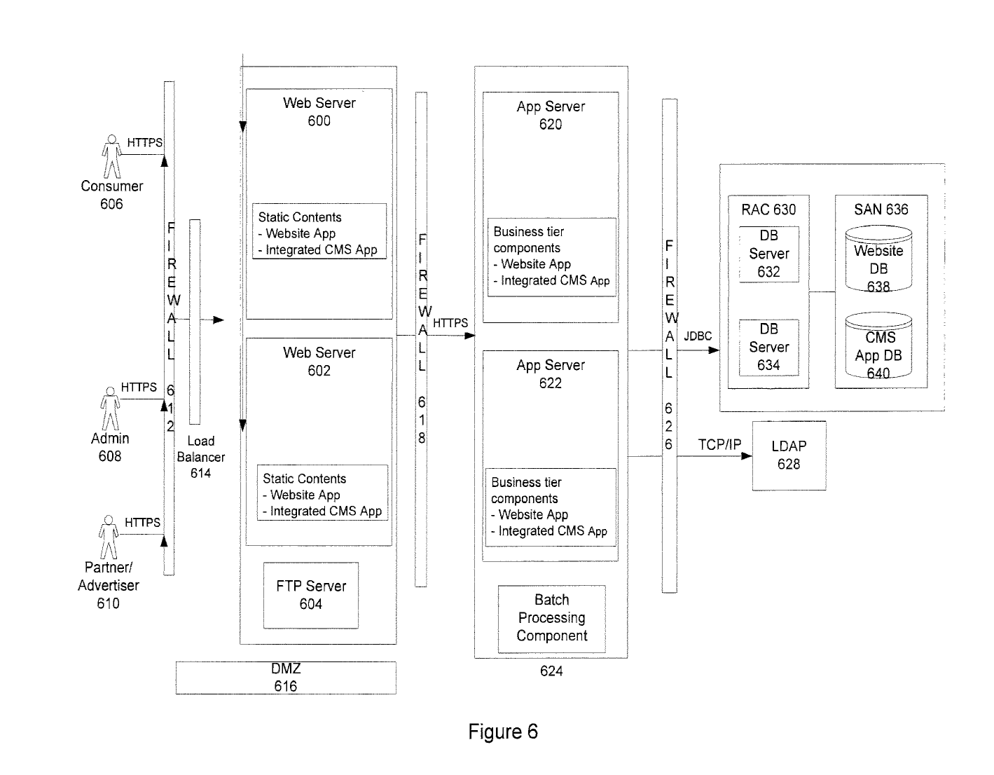

FIG. 6 illustrates the coupon system implementation in a distributed environment. Distribution of the coupon system components is relative to the aforementioned architectural tiers of the coupon system. Web servers 600 and 602 upon which the website application is implemented can be Apache HTTP Servers or some other server capable of accepting and service HTTP requests and responses, respectively. SSL is enabled in each of the web servers 600 and 602 to enforce all communication from users using HTTPS. It should be further noted that although two web servers are described herein, any number of web servers may be utilized in the coupon system. The web servers 600 and 602 also contain static files, such as HTML, JavaScript, CSS, images, and any other static content of a web page. Consumers 606 and partners/advertisers 610 communicate with the web servers 600 and 602 via the Internet. Administrator users 608 may communicate with the web servers 600 and 602 via the Internet as well, e.g., from within an intranet of the third-party coupon generator/distributor. All requests to the web servers 600 and 602 are routed via a firewall 612 for security. Partners 610 may also connect to one or more ftp servers 604 for downloading D2C integration data as described previously.

As further illustrated in FIG. 6, multiple application servers 620 and 622 are deployed in the application tier, and it should be noted that any number of application servers may be deployed in the coupon system in accordance with various embodiments. Such web servers may be implemented using, e.g., Oracle WebLogic Application Server 10.0 hosted in a Solaris environment. Clustering the application servers 620 and 622 provide a way to achieve load balancing and failover. However if server clustering, e.g., Oracle Weblogic Server clustering, is not feasible, a pseudo-clustered environment can be utilized by using a hardware-based load balancer 614. The load balancer 614 may be configured to be an entry point to the website application, where the load balancer 614 acts to balance the load across all web servers, e.g., web servers 600 and 602. Additionally, application servers 620 and 622 provide business tier components related to the integrated CMS application and the website application. Moreover, another firewall 618 may be implemented between the web servers 600 and 602 and the application servers 620 and 622. That is, all the requests from the web tier will be routed via the firewall 618, where the firewall 618 is configured to allow communication from the internal IP addresses of the web servers 600 and 602 and the ftp server 604 only. Application servers 620 and 622 can communicate with the database tier using JDBC connections which in turn will use an underlying Transmission Control Protocol/Internet Protocol (TCP/IP). Communications to an LDAP Server 628 are effectuated using an LDAP-specific custom protocol over TCP/IP protocol through a firewall 626.

It should be noted that the aforementioned web servers 600 and 602 and application servers 620 and 622 can refer to a physical hardware apparatus, such as a computer or processor upon which software for performing such processes is stored and executed. Alternatively, such servers may refer to the software itself, which by its nature requires some physical hardware apparatus for execution thereof. It should be further noted that the web servers 600 and 602 and the application servers 620 and 622 may be implemented in co-located servers or a single hardware apparatus/server.

Again, batch processing is performed via a batch processing component 624 implemented in the Solaris environment. Any job scheduling will be performed using the Solaris CRON utility discussed previously. Batch jobs will communicate with the database tier using JDBC over TCP/IP protocol.

The database tier, as illustrated in FIG. 6, shows two database servers 632 and 634, and the website database 638 and the integrated CMS application database 640. The databases servers 632 and 634 may be implemented using Oracle Database servers that are load balanced using an Oracle Real Application Clusters (RAC) environment 630. The application tier components communicate with the RAC 630 for connecting to one or more of the requisite databases instead of connecting to any specific server within the RAC 630. This substantially ensures failover management and proper load balancing by the RAC 630. Data is stored in an Oracle storage area network (SAN) 636. In accordance with one embodiment, only one copy of any data is maintained in the SAN 636, so that all of the database servers 632 and 634 within the RAC 630 share the same copy to the data. Alternatively, other data storage redundancy schemes may be used if desired. Again, more or less database servers and/or databases may be utilized to accommodate a desired amount of data to be stored.

As described above, the coupon system in accordance with various embodiments may provide for coupon distribution in the form of online printable coupons placed on a partner's microsite or dynamic coupon page, direct access, downloading, and printing via the coupon system website, or utilizing the D2C feature, where an offer can be linked to a loyalty card. Alternatively still and in accordance with yet another embodiment, the coupon system may provide offers in the form of, e.g., stand-alone print URLs. That is, instead of converting electronic coupons represented by HTML/visual representations into PDF documents for printing at home or some local printer, the offers are distributed as actual URLS or “links” on a partner website, or via e-mail, or otherwise indicated, as for example, through banner placements on one or more websites (whether partner-related, coupon system-related, or third-party-related), etc. It should be noted that each offer may be set up for distribution from more than one of these locations. Upon selection of the offer, one or more electronic coupons associated with the offer can be printed.

The coupon system in accordance with various embodiments may also provide for the distribution of coupons to users of portable and/or wireless electronic devices, such as wireless/smart telephones, e.g., iPhone® devices, RIM Blackberry® devices, and devices operating via the Android™ software stack, as well as e-reader devices, e.g., the Amazon Kindle™ and the iPad™, having “connectivity” functionality. Even “unconnected” devices, such as standalone e-readers, various PMP devices, etc. may receive coupons as an integrated part of an ePub document or other media content such as album art or video content, as will be discussed in greater detail below. It should be noted that the aforementioned devices and platforms are merely exemplary, and any device having media capabilities may receive and render such coupons in some form. It should also be noted that such devices may be utilized in cradles, holders, or the like, and physically attached to, e.g., a shopping cart, and as will be described below, may communicate with other networks, such as a Wi-Fi network hosted by a bricks and mortar store, an accessible retailer price network, etc.

In accordance with one embodiment, an application is provided at a consumer/user device, such as one of the aforementioned portable and/or wireless electronic devices, for receiving one or more coupons, advertisements, electronic FSIs, or other instances of promotional content, generated by the coupon system. The application may be a standalone application that is downloaded to or otherwise made available on the consumer device, e.g., by pre-loading the application during manufacture and/or configuration of the consumer device. Depending on the operating system or platform utilized by the consumer device, the application may be developed and/or adapted accordingly. For example, the standalone application may be developed using iOS SDK for the iPad™ or iPhone® platform. Java 2 Platform, Micro Edition (J2ME), as well as device-specific application programming interfaces (APIs) may be utilized to implement the standalone application for other devices. Additionally, U.S. Pat. Nos. 7,663,607 and 6,157,363 disclose systems and methods of controlling, e.g., touchscreen devices, as well as displaying data records, each of which is incorporated herein by reference. It should be noted that such implementations are merely exemplary, and any other known or future development tools may be utilized to effectuate various embodiments.

Alternatively, and as indicated above, promotional content may be embedded or included within a document, such as an ePub document or other visual or readable document. For example, an ePub document is a type of document created using an open e-book standard promulgated by the International Digital Publishing Forum designed for reflowable content, where text display can be optimized for a particular user device's display. Thus, instead of an ePub document merely containing the textual content of, e.g., a book or publication, the ePub document in accordance with various embodiments may also include one or more coupons, advertisements, etc. That is, at the end of each chapter of an ePub document or at a desired section of a digital newspaper, one or more coupons may be displayed to a user similar to the manner in which FSIs are included within paper publications such as, e.g., conventional newspapers or magazines. Further still, an electronic FSI may be implemented as its own ePub document. If the user device has the capability to access a data network such as the Internet, the one or more coupons included in an electronic FSI, for example, may provide/include one or more links or pointers to, e.g., an advertiser's webpage, a retailer's webpage, a partner microsite, etc. associated with the one or more coupons.

It should be noted that in addition to the aforementioned implementations, various embodiments may be realized through the interaction between embedded content and a standalone application. That is, the promotional content, such as coupons, advertisements, or electronic FSIs embedded in a document, such as an ePub document, may trigger the standalone application to be executed. For example, when a consumer/user comes upon embedded promotional content within an ePub document, the standalone application may be automatically executed to effectuate an interactive experience as described in greater detail below.

A standalone application may be used in conjunction with the coupon system to distribute and display one or more coupons, promotional content, etc. That is, such an application may be configured to determine when a user is utilizing, e.g., the iBooks™ application of an iPad™, so that when a user enters the Apple® Store, an electronic FSI may be displayed to the user. The electronic FSI may be associated with the purchase of e-books or other products/services, as desired. Alternatively, the standalone application may determine that the user has accessed a web browser, whereupon the standalone application accesses the coupon system to retrieve offers, or the standalone application is otherwise provided with one or more coupons/electronic FSIs appropriate for presentation with the homepage displayed to the user via the web browser. Alternatively still, the standalone application may be configured to display the one or more coupons/electronic FSIs upon an initial accessing of the web browser, or upon the user accessing a particular retailer's website via the web browser.

Further still, the standalone application may be configured to operate in conjunction with location-based services, such as those disclosed in U.S. Pat. Nos. 7,693,752 and 7,231,357, both of which are incorporated herein by reference. For example, when a user/consumer device's resident map functionality, or, e.g., the Google Maps™ application is accessed or utilized, one or more coupons/electronic FSIs may be displayed to the user. Additionally, regardless of what application/use triggers the standalone application, one or more coupons/electronic FSIs may be presented to a consumer based upon location, such that if a consumer is near, e.g., a grocery store, an electronic FSI targeted specifically for grocery products, that particular grocery store, or a loyalty card/frequent shopper card or account associated with the consumer may be displayed to the consumer. Identification of a consumer and a consumer's location can be achieved via Wi-Fi positioning and/or GPS positioning, depending upon, e.g., the capabilities of the consumer device, the determination of a location via zip code determination or manual/automatic entry of a zip code, etc. Moreover, and if, e.g., a retail location support geo-positioning within the location, location-based services may be utilized to direct a consumer to, e.g., a particular aisle where a desired product is located/displayed. Accordingly, the standalone application may display one or more coupons/electronic FSIs in conjunction with/as a shopping aisle overlay screen or display. For example, as a consumer approaches or passes by certain aisles/products, corresponding coupons/offers may be displayed, or an appropriate electronic FSI may be displayed upon entry into a particular store aisle. Alternatively, interaction with an electronic FSI may involve pop-up iconic/text menus indicative of shopping aisles in a particular shopping location.

In accordance with various embodiments, the aforementioned electronic FSI may be configured to present different user experiences depending upon the user to which the electronic FSI is presented. For example, when the electronic FSI is presented to a first-time user, the electronic FSI may be presented with hints and/or tips for interacting with the electronic FSI, or a “how to” page containing instructions for interacting with and using the electronic FSI in accordance with various embodiments. Moreover, the electronic FSI, whether presented to a first-time user or otherwise, may provide various full-help services to a user, such as a frequently-asked questions (FAQ) page(s), a self-help section(s), interactive support such as, e.g., a chat or telephonic help service. Such full-help services may exploit a device's resident or internal capabilities, such as initiating a chat session using, e.g., a resident messaging feature or application, or may be provided via the standalone application itself.

Presentation of the electronic FSI itself may be done in various formats and/or styles. For example, the electronic FSI may be presented in a portrait mode or a landscape mode, such as would be appropriate for the user device upon which the electronic FSI is rendered. If the user device is a standard telephone or smartphone, the electronic FSI may be presented in portrait form. However, if the user device is, e.g., a tablet PC, iPad™, or some other device that is utilized in a landscape orientation, or may switch between portrait and landscape modes, the electronic FSI can be presented in the appropriate orientation. Additionally, interacting with the electronic FSI can be accomplished based upon the capabilities of the user device upon which it is rendered. That is, interaction with the electronic FSI can be effectuated via, e.g., touch-screen control, joystick/mouse/trackpad/trackball control, hard keys, soft keys, etc.

Additionally, the presentation or rendering of the electronic FSI can be achieved in various ways. For example, if the electronic FSI is accessed or presented while a consumer is utilizing a web browser, the electronic FSI may be presented as simply another tab or page within the web browser. Alternatively, the electronic FSI may be presented as a new window or an overlay screen.

Upon first accessing the electronic FSI, a registration page may be presented to the user. The registration page may be configured to collect consumer information, such as a user's name, address information, email information, etc. Moreover, the registration page may allow the user to enter, e.g., information relating to one or more credit cards or payment accounts, one or more loyalty or frequent shopper card and/or account information, etc. Information such as credit card and loyalty card/account information can be verified via the standalone application as well. It should be noted that storage of such card/account information can be achieved locally, via the standalone application, remote storage, or use of, e.g., existing applications, such as the “Key Ring™” application. Based upon such collected information, a profile may be created for the particular user.

The profile may include, e.g., shopping preferences, such as a preferred retailers, whether such preferred retailers are bricks and mortar stores or online stores. The profile may also include a user's preference(s) regarding where, how, or under what circumstances the electronic FSI, coupons, advertisements, etc. are to be received and/or displayed. For example, a consumer may only wish to receive targeted promotional content that is location-based, or may only wish to receive coupons relating to a particular type of product, service, or retailer. The profile information may be stored locally on a user device or at a remote profile database controlled by and/or co-located with, e.g., the coupon system. Additionally, the profile information may be updated and/or modified at any time by the user via the standalone application or through remote access via the coupon system (e.g., the Consumer Access module 352 illustrated in FIG. 3) or other interface to the remote profile database.

When the electronic FSI is presented to or accessed by a non-first time user, the electronic FSI may simply present the appropriate promotional content to the user/consumer without the aforementioned hints/tips, how-to page, registration/profile creation aspects. Instead the user may immediately begin interacting with the electronic FSI.

The electronic FSI may contain a set of one or more coupons, advertisements, such as internally or externally ingested banner advertising, or other promotional content to be displayed on one or more pages. Unlike conventional, paper-based FSIs however, the electronic FSI provides an interactive experience for a user/consumer. That is, depending on the types of coupons or content contained in any particular electronic FSI, the coupons/content may be organized by one or more categories. For example, the coupons/content may be organized and/or searched by the type of product or service associated with a coupon or advertisement, a particular brand of product or service, a particular retailer, or any other “theme,” whether determined by a user, the coupon system, partner, etc., or any combination thereof. Moreover and based upon the various organization options described above, a user is able to, e.g., view the retailers participating in a particular offer or promotion before selecting or “clipping” a coupon of interest, described below. It should also be noted that the one or more coupons, advertisements, or other promotional content may be presented in various media formats. For example, electronic coupons such as those described above may be included in an electronic FSI. However, the promotional content included in an electronic FSI, or distributed independently of an electronic FSI may also be implemented as other media content, such as audio and/or short or long format video.

To interact with the electronic FSI, a user may navigate the one or more pages of a particular electronic FSI. If the user is interested in a particular coupon, advertisement, or other promotional content contained in a particular electronic FSI, the user may click or select, e.g., a coupon of interest. Clicking or selecting a coupon may direct the user to “static” information regarding the coupon or product/service associated with the coupon, e.g., information about the company, retailer, brand, or other information associated with the product/service. Such information may be embedded within the particular FSI or may be downloaded or accessed upon the user selecting the coupon from, e.g., the coupon system, a partner site, a partner microsite, etc. Alternatively and as described above, selecting a coupon may result in linking to a webpage of the company, retailer, brand, etc. associated with the coupon.

Additionally, selection of a coupon allows the user to electronically “clip” the coupon for use by the user. For example, clipping a coupon of interest may result in electronically storing the coupon or information associated with the coupon, where such information can be contained within the coupon itself or retrieved from the coupon system, partner site, partner microsite, etc. That is, and as described above, the coupon may be sent to a printer for printing and manual redemption at a point-of-sale location, such as a register, kiosk, or other redemption location/center.

Relevant information regarding the coupon may also be rendered on the user device itself. For example, a one-dimensional, two-dimensional, or even three-dimensional barcode, coupon identification, or other visual representation of the coupon may be displayed on the user device. Thus, the user may present the user device at a point-of-sale location, where the relevant coupon information can be scanned, retrieved, or otherwise sent to the point-of-sale location for redeeming the coupon. U.S. Pat. Nos. 7,257,545 and 7,555,444 describe systems and methods for rendering readable barcode/coupon information on mobile devices, each of which is incorporated herein by reference.

Alternatively, the coupon may be stored for use with an online retailer, such that when a user navigates to an online retailer webpage using the user device, selection of a product via the online retailer webpage will trigger the retrieval of the previously clipped coupon. Alternatively still, and as described above, upon the user being directed/linked to, e.g., a retailer webpage, the coupon may be redeemed immediately. For example, electronically clipping a coupon for a particular product, will direct the user to an online retailer of that particular product, whereupon the user is automatically taken to a checkout page or screen of that online retailer. The user may then confirm the amount of the particular product to be purchased, enter shipping and payment information, etc. Shipping and payment information may also be automatically retrieved from the user profile locally stored via the standalone application as described above or, e.g., retrieved from the User Profile Module 358 illustrated in FIG. 3, and automatically entered if so desired by the user. The online retailer may be chosen at random, predetermined by the user as a preferred retailer, determined by a price and/or shipping cost associated with purchasing the product, etc., or some combination thereof. Various types of known filters and/or algorithms can be utilized to make such determinations and choices.

In accordance with yet another embodiment, the selected coupon may be linked to a loyalty or frequent shopper card/account, as described above with respect to the D2C functionality of the coupon system. The D2C functionality may be configured to operate in real-time upon selection of a coupon, or the linking of the coupon to a loyalty or frequent shopper card/account may be performed at some later point in time. For example, user devices that do not have communication capabilities may be physically “synced” at a user's PC, where the loyalty or frequent shopper card/account information is stored at the user's PC. Additionally and as also described above, a user may be associated with one or more loyalty or frequent shopper cards/accounts. In the event that a user has a plurality of such cards/accounts, the standalone application provides the capability of categorizing and/or sorting, e.g., coupons, for presentation in a particular electronic FSI based on their relevance to each of the plurality of cards/accounts. Additionally, when a coupon is selected or clipped by a user, the coupon can be automatically or manually directed to one of the plurality of cards/accounts based on one or more criteria, such as the type of product associated with the coupon, the brand of product associated with the coupon, whether or not the coupon can be redeemed at a retailer associated with the card/account, etc. Moreover, coupons, promotional content, etc. may be shifted between various loyalty cards/frequent shopper cards or accounts. Alternatively, a coupon can be associated to more than one loyalty/frequent shopper card or account.

Alternatively and in addition to the D2C functionality, the standalone application or the standalone application in conjunction with the coupon system may used as a repository for such loyalty card/frequent shopper card or account information, where other resident applications may access the standalone application for use with separate purchases. For example, if a consumer utilizes his/her consumer device to effectuate an online purchase via a web browser, the web browser may access the standalone application to retrieve any applicable loyalty/frequent shopper information for association with the online purchase.

Further still, selecting a coupon may direct or give the option to a user to be directed to view other, e.g., related coupons/offers/promotions. Moreover, the user may be provided with the option to complete one or more surveys, and/or input additional information upon which future targeted advertising and/or promotional content can be based. The user may also be provided with the option to request a sample of the product associated with a coupon or advertisement for standard mail fulfillment. Further still, and in addition to the RSS embodiments described above, other embodiments can effectuate the sharing of coupons, if allowed, using social networking functionality, such as MySpace™, Facebook®, Twitter™, Foursquare™, etc.

The standalone application in accordance with another embodiment also provides a user with the ability to store and/or sort previously clipped or selected coupons from an electronic FSI. That is, either automatically or at the user's discretion, the selection of a coupon of interest can result in a particular coupon being stored in a listing of favorite or saved coupons. Such a list can thereafter be accessed by the user when, e.g., creating a shopping list, or simply to create a cache of coupons to be used in the future. Additionally, the selection of coupons can be tracked by the coupon system and provided to, e.g., retailers, partners, etc. for statistical record-keeping, demographic use data, or other informational purposes.

As indicated above, shopping lists can be created via the selection of coupons presented to a user, either separately or in, e.g., an electronic FSI. For example, when a coupon is selected or clipped, a shopping list is created and populated (automatically or at the discretion of the user) with the product or service associated with the coupon. The shopping list may then be emailed, printed, or shared with another person, e.g., family member. More than one shopping list may be created and maintained by the standalone application and user device locally, or remotely, as at the User Profile Module 358 of FIG. 3, where different ones of the plurality of shopping lists may be associated with particular products, e.g., grocery products, baby products, etc. Shopping lists may also be created and/or categorized based on particular retailers, currently available coupons or offers, or other criteria, or combination thereof. Additionally, the standalone application may perform or trigger price-sensitive searching based upon the product(s)/service(s) placed in the shopping list by, e.g., real-time querying of retailer price files, thus optimizing potential savings for a consumer. For example, and in conjunction with the above-described location-based functionality of various embodiments, a consumer may utilize the standalone application to check prices of products or interest or products for which coupons or promotional offers have been distributed or are available to the consumer.

The standalone application may also integrate with other online websites, services, etc. For example, the standalone application may link or connect to, e.g., recipe/lifestyle sites and perform searches of recipes, for example, that include one or more food products in the shopping list that was created, thus enhancing the interactive experience of the consumer.

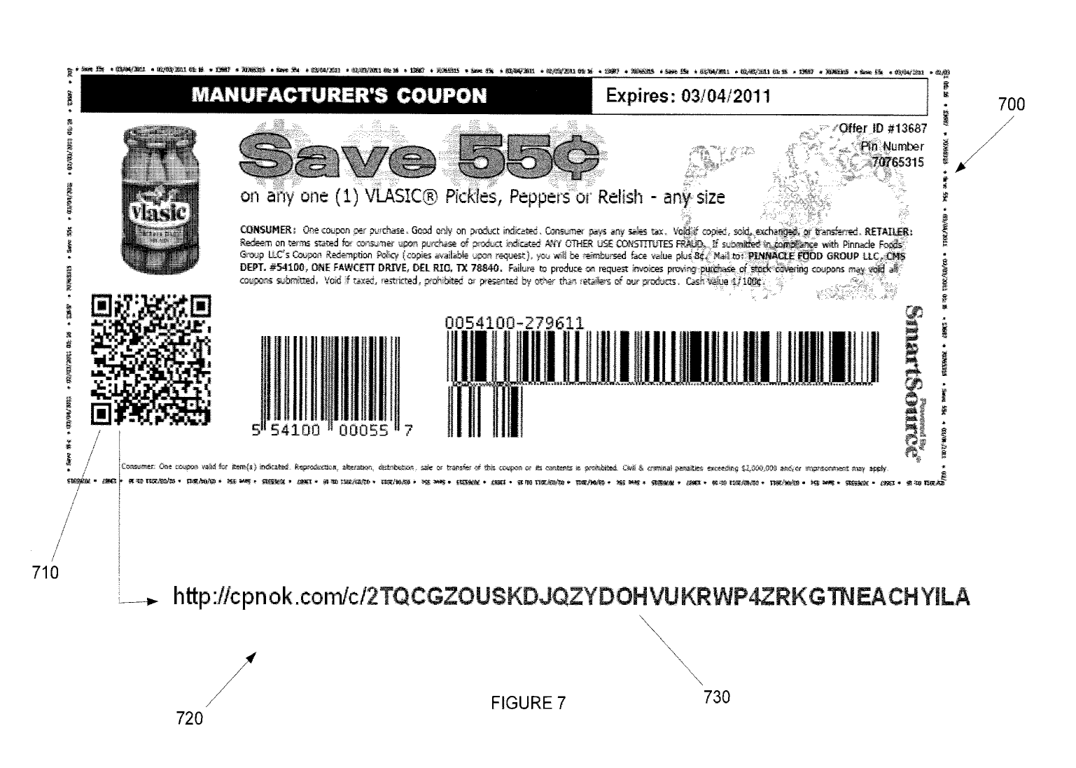

FIG. 7 illustrates an exemplary implementation of an electronic FSI on a tablet PC in accordance with various embodiments. Tablet PC 700 may be a tablet laptop, an e-reader, an iPad™, or other similar device. The tablet PC 700 includes a display 705 that may have various application icons 710 presented thereon. As described above, an electronic FSI 715 may be displayed on the display 705 as, e.g., an overlay screen or window. The electronic FSI 715 may present one or more coupons, advertisements, and/or other promotional content 720, where such coupons, advertisements, and/or promotional content may be organized, sorted, categorized as described above. Upon selection of a coupon 725, various actions may be performed, either automatically or manually at the discretion of a user. In this particular embodiment, a menu 730 is displayed to the user giving options for effectuating the various actions, such as, e.g., creating a new shopping list, sending the selected coupon 725 to an existing shopping list, routing the selected coupon 725 to a loyalty card/frequent shopper account, applying a discount associated with the selected coupon 725 in real-time, etc. Alternatively and as described above, a notification window/alert may be displayed indicating default or automatic actions, such as the automatic routing of products to one or more shopping lists, or an alert indicating that the user will be taken to an e-commerce website, etc. Additionally, the electronic FSI 715 may have more than one page or window of coupons, advertisements, and/or promotional content. Controls 735 for navigating the multiple pages/windows of the electronic FSI 715 may also be provided to the user. It should be noted that when the electronic FSI 715 does include multiple pages, the electronic FSI 715 may be downloaded to the table PC 700 in its entirety, or in the background and in sections, such as page-by-page, thereby allowing the user to access the electronic FSI 715 more immediately.

The coupon system may additionally “warehouse” coupons or may maintain active and/or expired coupons in a separate database or repository. Moreover, coupons or coupon information can be retrieved from a separate coupon website/repository, via electronic coupon scanning/coupon dispenser, location-based service provided coupons, and/or other sources of promotional content. For example, coupons/coupon information can be scanned from traditional paper-based FSIs. Additionally, barcodes, such as two-dimensional barcode images can be scanned by the consumer/user device and stored for display within, e.g., a personalized electronic FSI. Systems and services for scanning barcode images have been developed by, e.g., JAGTAG, and Symbology, Inc., where a two-dimensional barcode can be scanned thereby effectuating retrieval of a coupon or discount offer from, e.g., the coupon system, retailer, or other discount offerer. Additionally still, offers may be scanned at, e.g., shelf coupon dispensers or kiosks, whether via barcode scanning, RFID or other wireless or wired transmission. Even existing coupons or promotional offers received via email, text or multimedia messaging, location-based and communication service provider promotional content may be received by the consumer/user device and stored for presentation in the personalized electronic FSI. As described above, any received promotional content or information may be printed, automatically redeemed, rendered on the user device, etc.

According to one embodiment, the user/consumer device can be configured to work in conjunction with mobile marketing programs. For example, Quick Response (QR) codes and/or text numbers may be displayed in in-store or home delivered advertising. A QR code is a specific matrix barcode, readable by dedicated QR barcode readers. QR barcode reader software can be downloaded and ran on the user/consumer device. The user/consumer device can be configured to scan two-dimensional barcode images that are Quick Response (QR) codes. The user/consumer device is also configured to send a text message via any known method.

Accordingly, a user/consumer device may scan a QR code or send a text message displayed in in-store or home delivered advertising. In return, the user/consumer device receives brand information, coupons or can request samples.

Further still, product identifiers such as, e.g., UPC codes, may be scanned as described above, in addition to actual coupons, advertisements, or promotional content, such that scanned product information may also be added to a shopping list or identified for automated replenishment via, e.g., a retailer e-commerce account. The scanning of product identifiers may also be utilized as a prompt or trigger for coupons and discount offers, such that upon the scanning of product identifier information, the standalone operation links to, e.g., a retailer/partner site or database, the coupon system, etc. to determine whether any offers are available for that particular product. Alternatively, the standalone application may periodically or aperiodically connect to the aforementioned retailer/partner site or database, or coupon system, and the one or more shopping lists or saved coupon lists can be analyzed to determine whether or not offers exist for the products within those lists. Hence, a consumer is able to wait for the opportune time to purchase a product, i.e., when a coupon or discount offer is available for that product. Products on a shopping list may also be “checked off” once a consumer scans a product. Once the standalone application is aware of product pricing as described above, alerts or notifications may be presented to a consumer indicating that, e.g., a different brand of product is cheaper than that previously scanned by the consumer as described below. Moreover, the standalone application can function as a virtual point-of-sale, where a running total of scanned products may be displayed to the consumer, along with any savings or applicable discounts realized from the electronic FSI, coupons, promotional offers, etc. Furthermore, instead of store personnel manually re-scanning items/products at the point-of-sale register, the user device may, e.g., wirelessly transmit information regarding the scanned items to the point-of-sale register.

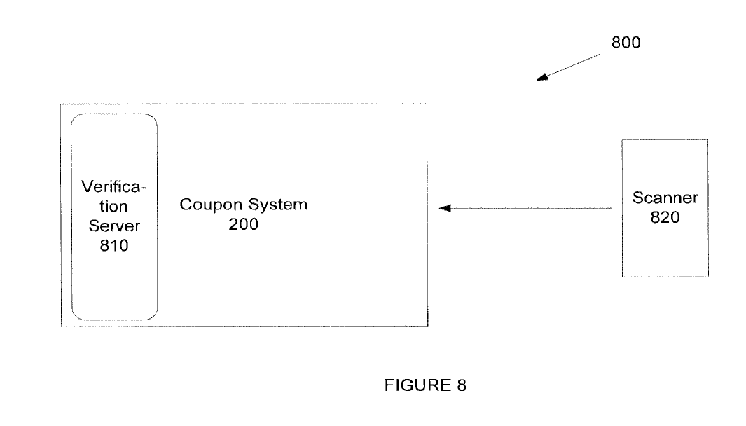

FIG. 8 illustrates an exemplary tablet couponing system architecture in accordance with various embodiments. As described above, promotional content and/or information may be received from the coupon system 800, a coupon website 805, a scannable coupon source/coupon dispenser 810, a communication service provider/location-based service coupon provider 815, an electronic FSI generator 820 (in accordance with embodiments where an electronic FSI is distributed to a consumer as opposed to, e.g., the standalone application or coupon system, generating the electronic FSI) or and/or any other provider or repository 825 of promotional content. Such promotional content may be received at consumer/user device 830, which as described above, may comprise a tablet PC, a smartphone, a laptop PC, etc. Receipt may be effectuated via, e.g., various “push” technology from a publisher/server such as one or more of the above entities to the consumer/user device 830. Within the consumer/user device 830, and depending on the configured or user-determined actions to be executed based on the promotional content, a shopping list module 835 may process the promotional content to create or add products to a shopping list. A mobile coupon rendering module 840 may render a coupon or coupon information so that, e.g., a point-of-sale register can receive the requisite coupon information to be applied towards a product purchase. Additionally, a favorites/saved coupons module 845 may store clipped or accessed coupons for the user, while an object (coupon, product, etc.) scanning module 850 may be utilized for the scanning of product identifiers as described above. Furthermore, and as also described above, a coupon may be printed at a printer 855, associated with one or more loyalty/frequent shopper cards/accounts via a D2C partner 860, or redeemed online via an online retailer system 865. Communications between the consumer/user device 830 and the various entities, e.g., the coupon system 800, an online retailer 860, etc. may be effectuated through the use of interfaces, such as APIs. Moreover, communication between the various modules may also be effectuated via, e.g., APIs, as well.

In addition to various embodiments described herein directed to features and capabilities from a consumer perspective, various embodiments also provide a plurality of control options for, e.g., a partner, advertiser, etc. That is, various embodiments may effectuate limits on coupon usage to allow consumer packaged goods companies, for example, to determine a desired amount of redemptions per discount or promotional offer. Limits or parameters may also be set to control the number of, e.g., retailers, that one or more particular coupons may be linked to. For example, a consumer may be limited to, e.g., use with only 2 retailers. To achieve such control, coupons may be retained in, e.g., the aforementioned coupon system, or other coupon warehouse/repository along with an indicator or counter to keep track of remaining allowable uses for such coupons. Geo-location based detection can be utilized to then download a coupon to a user device or loyalty card or account. Additionally and if, for example, a coupon goes unused, the coupon may be returned for later use. It should be noted that in embodiments where coupons, advertisements, or other promotional content may be shifted, downloaded and returned, etc., it is preferable that only copies of a coupon or requisite information/data necessary to redeem a coupon (along with the requisite security measures) need to be distributed. Hence, the integrity of an offer, coupon, etc. may be maintained.

Various techniques may be used to limit the number of accessible coupons and reduce the chances for fraudulent redemptions. For example, if a coupon transferred to the coupon system of the user device originates as a printed coupon from, e.g., a traditional FSI, through scanning the barcode for such coupon, the system may be configured to allow only one usage of such transferred coupon, as the user would remain able to redeem the original paper coupon as well.

Communications described herein may be effectuated via any combination of wired or wireless networks including, but not limited to, a mobile telephone network, a wireless Local Area Network (LAN), a Bluetooth personal area network, an Ethernet LAN, a token ring LAN, a wide area network, the Internet, etc. For exemplification, a mobile telephone network may provide connectivity of a consumer/user device with the Internet. Connectivity to the Internet may include, but is not limited to, long range wireless connections, short range wireless connections, and various wired connections including, but not limited to, telephone lines, cable lines, power lines, and the like. The consumer/user devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A consumer/user device may communicate using various media including, but not limited to, radio, infrared, laser, cable connection, and the like.

An exemplary consumer/user device within which various embodiments described herein may be implemented may include a housing, a display in the form of a liquid crystal display and/or a keypad, a microphone, an audio speaker, a battery, one or more I/O ports, one or more antennas, a smart card in the form of a UICC according to one embodiment of the invention, a card reader, radio interface circuitry, codec circuitry, a controller/processor, and a memory. Individual circuits and elements are all of a type well known in the art.

Various embodiments are described herein with reference to drawings. These drawings illustrate certain details of specific embodiments that implement the systems and methods and programs of the present invention. However, describing the invention with drawings should not be construed as imposing on the invention any limitations that may be present in the drawings. Various embodiments contemplate methods, systems and program products on any machine-readable media for accomplishing its operations. The embodiments of the present invention may be implemented using an existing computer processor, or by a special purpose computer processor incorporated for this or another purpose or by a hardwired system.

As noted above, various embodiments include computer program products embodied or encoded on, e.g., a non-transitory computer/machine-readable media (e.g., memory) for carrying or having machine-executable instructions or data structures stored thereon. Such computer/machine-readable media can be any available media which can be accessed by a general purpose or special purpose computer, server, or other machine with a processor or controller. By way of example, such computer/machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures. When information is transferred or provided over a network or another communications connection (either hardwired, wireless, or a combination of hardwired or wireless) to a machine, the machine properly views the connection as, e.g., a transitory computer/machine-readable medium. Combinations of the above are also included within the scope of computer/machine-readable media. Machine-executable instructions comprise, for example, instructions and data which cause a general purpose computer, special purpose computer, or special purpose processing machines to perform a certain function or group of functions.

Various embodiments are also described in the general context of method processes which may be implemented in one embodiment by a program product including machine-executable instructions, such as program code, for example in the form of program modules executed by machines in networked environments. Generally, program modules include routines, programs, objects, components, data structures, etc. that perform particular tasks or implement particular abstract data types. Machine-executable instructions, associated data structures, and program modules represent examples of program code for executing processes of the methods disclosed herein. The particular sequence of such executable instructions or associated data structures represent examples of corresponding acts for implementing the functions described in such processes and it is understood that the order of these processes may differ from what is depicted. Also two or more processes may be performed concurrently or with partial concurrence. Such variation will depend on the software and hardware systems chosen and on designer choice. It is understood that all such variations are within the scope of the invention. Likewise, software and web implementations of the present invention could be accomplished with standard programming techniques with rule based logic and other logic to accomplish the various database searching processes, correlation processes, comparison processes and decision processes. It should also be noted that the words “component” and “module” as used herein and/or in the claims is intended to encompass implementations using one or more lines of software code, and/or hardware implementations, and/or equipment for receiving manual inputs.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

The foregoing description of embodiments of the invention has been presented for purposes of illustration and description. It is not intended to be exhaustive or to limit the invention to the precise form disclosed. The embodiments were chosen and described in order to explain the principals of the invention and its practical application to enable one skilled in the art to utilize the invention in various embodiments and with various modifications as are suited to the particular use contemplated. Other substitutions, modifications, changes and omissions may be made in the design, operating conditions and arrangements of the preferred and other exemplary embodiments without departing from the spirit of the present invention.

What is claimed is:

1. A method performed using a portable electronic device, comprising:
creating a shopping list on the portable electronic device including at least one product, the at least one product being a subject of at least one coupon offer presented on the portable electronic device;
querying a price file database of at least one user-selectable retailer for brand pricing associated with the at least one product;
receiving brand pricing information for the at least one product; and
including the brand pricing information in the shopping list.

2. The method of claim 1 further comprising, presenting a notification indicative of a lowest brand pricing associated with the at least one product.

3. The method of claim 2, wherein the presentation of the notification is performed via an application through which the at least one coupon offer is presented, the application being resident upon the portable electronic device.

4. The method of claim 1 further comprising, presenting at least one purchase suggestion representative of a lowest overall pricing associated with the at least one product based upon the brand pricing information for the at least one product and the at least one coupon offer.

5. The method of claim 1, wherein the querying of the price file database is performed via a wireless communication function of the portable electronic device.

6. The method of claim 1, wherein the querying of the price file database is performed in real-time.

7. The method of claim 1, wherein the querying of the price file database is performed periodically.

8. The method of claim 1, wherein the price file database of the at least one user-selectable retailer is selectable for querying based upon a location of the portable electronic device.

9. The method of claim 1 further comprising, selecting the price file database of the at least one user-selectable retailer for querying based upon a predetermined selection made by a user of the portable electronic device.

10. The method of claim 1 further comprising, presenting the at least one coupon offer based upon a location of the portable electronic device.

11. The method of claim 1 further comprising, linking the at least one coupon offer to a loyalty account associated with the at least one user-selectable retailer.

12. An apparatus, comprising:
a processor; and
a memory unit operatively connected to the processor and including:
computer code configured to receive an indication of a selected coupon, the selected coupon being presented via at least one coupon offer rendered on a display of the apparatus;
computer code configured to create a shopping list including at least one product, the at least one product being a subject of the selected coupon;
computer code configured to query a price file of at least one user-selectable retailer for brand pricing associated with the at least one product;
computer code configured to receive brand pricing information for the at least one product; and
computer code configured to include the brand pricing information in the shopping list.

13. The apparatus of claim 12, wherein the memory unit further includes computer code configured to present a notification indicative of a lowest brand pricing associated with the at least one product.

14. The apparatus of claim 13, wherein the presentation of the notification is performed via an application resident on the apparatus through which the at least one coupon offer is presented.

15. The apparatus of claim 12, wherein the apparatus further comprises a wireless communication function through which the querying of the price file is effectuated.

16. The apparatus of claim 12, wherein the memory unit further includes computer code configured to present at least one purchase suggestion representative of a lowest overall pricing associated with the at least one product based upon the brand pricing information for the at least one product and the at least one coupon offer.

17. The apparatus of claim 12, wherein the computer code configured to query the price file is executed by the processor in real-time.

18. The apparatus of claim 12, wherein the computer code configured to query the price file is executed by the processor periodically.

19. The apparatus of claim 12, wherein the memory unit further comprises computer code configured to select the price file of the at least one user-selectable retailer for querying based upon a location of the apparatus.

20. The apparatus of claim 12, wherein the memory unit further comprises computer code configured to select the price file of the at least one user-selectable retailer for querying based upon a predetermined selection made by a user of the apparatus.

21. The apparatus of claim 12, wherein the memory unit further comprises computer code configured to present the at least one coupon offer based upon a location of the apparatus.

22. The apparatus of claim 12, wherein the memory unit further comprises computer code configured to link the at least one coupon to a loyalty account associated with the at least one user-selectable retailer.

23. A method performed on a portable electronic device, comprising:
rendering a plurality of coupon offers on the portable electronic device, the plurality of coupon offers representing an associated plurality of electronic coupons;
upon selection of at least one coupon offer of the plurality of coupon offers, linking at least one electronic coupon of the associated plurality of electronic coupons to a first retailer loyalty account; and
upon occurrence of an event, one of linking the at least one electronic coupon to a second retailer loyalty account, and transferring the at least one electronic coupon to a coupon repository.

24. The method of claim 23, wherein the selection of the at least one coupon offer is performed by a consumer utilizing the portable electronic device.

25. The method of claim 23, wherein the linking of the at least one electronic coupon to the first retailer loyalty account comprises transmitting redemption information associated with the at least one electronic coupon to a direct-to-card partner server.

26. The method of claim 23, wherein the event comprises a period of time during which the at least one electronic coupon is not redeemed.

27. The method of claim 23, wherein the event comprises a consumer linking the at least one electronic coupon to the second retailer loyalty account or transferring the at least electronic coupon to the coupon repository.

28. The method of claim 23 further comprising, retrieving the at least one electronic coupon from one of the second retailer loyalty account and the coupon repository for subsequent redemption.

29. The method of claim 28, wherein the coupon repository comprises a plurality of coupon offers received from a plurality of coupon distribution sources, and the subsequent redemption comprises one of paper-based redemption and electronic-based redemption.

30. The method of claim 23, wherein the coupon repository maintains redemption data associated with the at least one electronic coupon.

31. The method of claim 23, wherein subsequent to the linking of the at least one electronic coupon to the second retailer loyalty account, retaining the link between the at least one electronic coupon to the first retailer loyalty account.

32. The method of claim 23, wherein subsequent to the linking of the at least one electronic coupon to the second retailer loyalty account, eliminating the link between the at least one electronic coupon to the first retailer loyalty account.

33. The method of claim 23 further comprising, choosing the first retailer loyalty account and the second retailer loyalty account based upon a location of the portable electronic device.

34. An apparatus, comprising:
a processor; and
a memory unit operatively connected to the processor and including:
computer code configured to render a plurality of coupon offers on the apparatus, the plurality of coupon offers representing an associated plurality of electronic coupons;
computer code configured to, upon selection of at least one coupon offer of the plurality of coupon offers, link at least one electronic coupon of the associated plurality of electronic coupons to a first retailer loyalty account; and
computer code configured to, upon occurrence of an event, either link the at least one electronic coupon to a second retailer loyalty account, or store the at least one electronic coupon in a coupon repository.

35. The apparatus of claim 34, wherein the computer code configured to link the at least one electronic coupon to the first retailer loyalty account is further configured to transmit redemption information associated with the at least one electronic coupon to a direct-to-card partner server.

36. The apparatus of claim 34, wherein the event comprises a period of time during which the at least one electronic coupon is not redeemed.

37. The apparatus of claim 34, wherein the event comprises a consumer linking the at least one electronic coupon to the second retailer loyalty account or transferring the at least electronic coupon to the coupon repository.

38. The apparatus of claim 34, wherein the memory unit further comprises computer code configured to retrieve the at least one electronic coupon from one of the second retailer loyalty account and the coupon repository for subsequent redemption.

39. The apparatus of claim 38, wherein the coupon repository comprises a plurality of coupon offers received from a plurality of coupon distribution sources, and the subsequent redemption comprises one of paper-based redemption and electronic-based redemption.

40. The apparatus of claim 34, wherein the coupon repository maintains redemption data associated with the at least one electronic coupon.

41. The apparatus of claim 34, wherein the memory unit further comprises computer code configure to, subsequent to the linking of the at least one electronic coupon to the second retailer loyalty account, retain the link between the at least one electronic coupon to the first retailer loyalty account.

42. The apparatus of claim 34, wherein the memory unit further comprises computer code configure to, subsequent to the linking of the at least one electronic coupon to the second retailer loyalty account, eliminate the link between the at least one electronic coupon to the first retailer loyalty account.

43. A method performed on a portable electronic device, comprising:
receiving on the portable electronic device at least one product identifier associated with at least one product available for purchase at a retail location;
recording the at least one product identifier; and
upon a determination to purchase the at least one product, transferring from the portable electronic device to a point-of-sale processor at the retail location, the at least one product identifier.

44. The method of claim 43 further comprising, denoting acquisition of the at least one product via a shopping list, the shopping list being presented on the portable electronic device and including an indication of the at least one product.

45. The method of claim 44 further comprising, presenting at least one of a running price total associated with the shopping list and any available coupon offer associated with the at least one product.

46. The method of claim 45, wherein the running price total includes potential price savings based upon the available coupon offer.

47. The method of claim 43, wherein the transferring of the at least one product identifier to the point-of-sale processor is performed via a wireless communication functionality of the portable electronic device.

48. The method of claim 43, wherein the at least one product identifier comprises a universal product code.

49. The method of claim 43, wherein the receipt of the at least one product identifier is accomplished by one of scanning, wireless transmission, and manual entry to the portable electronic device.

50. The method of claim 43 further comprising, presenting alternative pricing associated with the at least one product.

51. The method of claim 43 further comprising, transferring from the portable electronic device to the point-of-sale processor, any available coupon offer associated with the at least one product in conjunction with the transferring of the at least one product identifier.

52. An apparatus, comprising:
a processor; and
a memory unit operatively connected to the processor and including:
computer code configured to receive at least one product identifier associated with at least one product available for purchase at a retail location;
computer code configured to record the at least one product identifier; and
computer code configured to, upon a determination to purchase the at least one product, transfer from the apparatus to a point-of-sale processor at the retail location, the at least one product identifier.

53. The apparatus of claim 52, wherein the memory unit further comprises computer code configured to denote acquisition of the at least one product via a shopping list, the shopping list being presented on the portable electronic device and including an indication of the at least one product.

54. The apparatus of claim 53, wherein the memory unit further comprises computer code configured to present at least one of a running price total associated with the shopping list and any available coupon offer associated with the at least one product.

55. The apparatus of claim 54, wherein the running price total includes potential price savings based upon the available coupon offer.

56. The apparatus of claim 52, wherein the computer code configured to transfer the at least one product identifier to the point-of-sale processor is executed via a wireless communication module of the portable electronic device.

57. The apparatus of claim 52, wherein the at least one product identifier comprises a universal product code.

58. The apparatus of claim 52, wherein the computer code configured to receive the at least one product identifier further comprises computer code configured to receive the at least one product identifier by one of scanning, wireless transmission, and manual entry.

59. The apparatus of claim 52, wherein the memory unit further comprises computer code configured to present alternative pricing associated with the at least one product.

60. The apparatus of claim 52, wherein the memory unit further comprises computer code configured to transfer from the apparatus to the point-of-sale processor, any available coupon offer associated with the at least one product in conjunction with the transfer of the at least one product identifier.
